(19) United States
(12) Patent Application Publication
(10) Pub. No.: US 2008/0160945 A1
(43) Pub. Date: Jul. 3, 2008

(54) AUTOMATIC GAIN CONTROLLER FOR RF TRANSCEIVER

(75) Inventors: Guillaume Crinon, Douvres-la-Delivrande (FR); Rouxel Alexandre, Mathieu (FR)

Correspondence Address: HOWISON & ARNOTT, L.L.P, P.O. BOX 741715, DALLAS, TX, 75374-1715, US

(73) Assignee: SILICON LABORATORIES INC., AUSTIN, TX (US)

(21) Appl. No.: 11/618,425

(22) Filed: Dec. 29, 2006

(51) Int. Cl. H04B 1/06

(52) U.S. Cl. 455/234.1

(57) ABSTRACT

The present invention comprises an automatic gain controller for an RF transceiver that comprises a digital engine that selects a gain level responsive to a signal power level of a signal of interest received by the RF transceiver. The digital engine is configured to select the gain level from a plurality of possible gain levels to maximize the signal power of the signal of interest while providing at least a selected signal of interest to noise ratio. The digital engine provides a control signal enabling amplification of a received signal according to the selected gain level.

### TECHNICAL FIELD OF THE INVENTION

The present invention relates to automatic gain controllers, and more particularly to automatic gain controllers for use with RF transceivers of the type utilized with the IEEE 802.15.4 standard.

### BACKGROUND OF THE INVENTION

Portable RF transceivers such as those utilizing the IEEE 802.15.4 standard require the ability to easily detect signals of interest while minimizing the effects of noise and interferer signals within the wireless network. Interferer signals comprise other transmitted signals which may be received by an RF transceiver that are not of interest to the receiving RF transceiver but introduce energy within the desired operating band of the radio, and thus constitute an additional energy source, which the RF transceiver must take into account. In order to overcome this problem, RF transceivers may have associated therewith automatic gain controllers enabling the gain of various amplifiers associated with the RF transceiver to control the gain levels applied to the receive signals to maximize the receipt potential of signals of interest while minimizing the interference caused by both noise and interferer signals. These automatic gain controllers typically adjust the received signal strength of the in band signal to a desired analog level to primarily insure that there is no saturation of the radio front end. However, they adjust the gain of the front end based on the entire received signal comprised of the signal of interest, the possible interferer and the noise. If the gain is set too high, the interferer signal may be amplified to too large a value, potentially causing problems with the signal of interest. Likewise, if the gain level is set to low, unexpected spikes within the noise level at the RF transceiver may cause the signal of interest to be lost. Thus, there is a need for an effective method and apparatus for providing an automatic gain controller with an RF transceiver.

### SUMMARY OF THE INVENTION

The present invention, as disclosed and described herein, comprises an automatic gain controller for an RF transceiver. The automatic gain controller consists of a dedicated digital engine configured to select a gain level responsive to a selected signal to noise ratio of a signal received by the RF transceiver. The signal that is the subject of the signal to noise ration is the expected received signal—the “signal of interest.” Any other received signals are treated as if it were noise. The digital engine is configured to select the gain level from a plurality of possible gain levels as a function of both the ratio of the signal of interest to the combined other received signals and noise and the dynamic range of the receiver.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates wireless communication amongst a plurality of portable RF transceivers;

FIG. 2 is a block diagram of an RF transceiver chip;

FIG. 3 is a block diagram of an analog portion of the RF transceiver chip of FIG. 1;

FIG. 4 is a block diagram of the digital portion of the RF transceiver chip of FIG. 1;

FIG. 5 is an illustration of the automatic gain controller implemented in a digital signal processor;

FIG. 6 illustrates the signals potentially received by an RF transceiver;

FIG. 7 is a flow diagram illustrating the operation of the digital signal processor implementing the automatic gain controller;

FIG. 8 illustrates the margin level between the signal level of a signal of interest in the noise level of unwanted signals; and

FIG. 9 illustrates the manner in which a particular gain level may be selected to achieve a desired margin level for the signal to noise ratio.

### DETAILED DESCRIPTION OF THE INVENTION

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

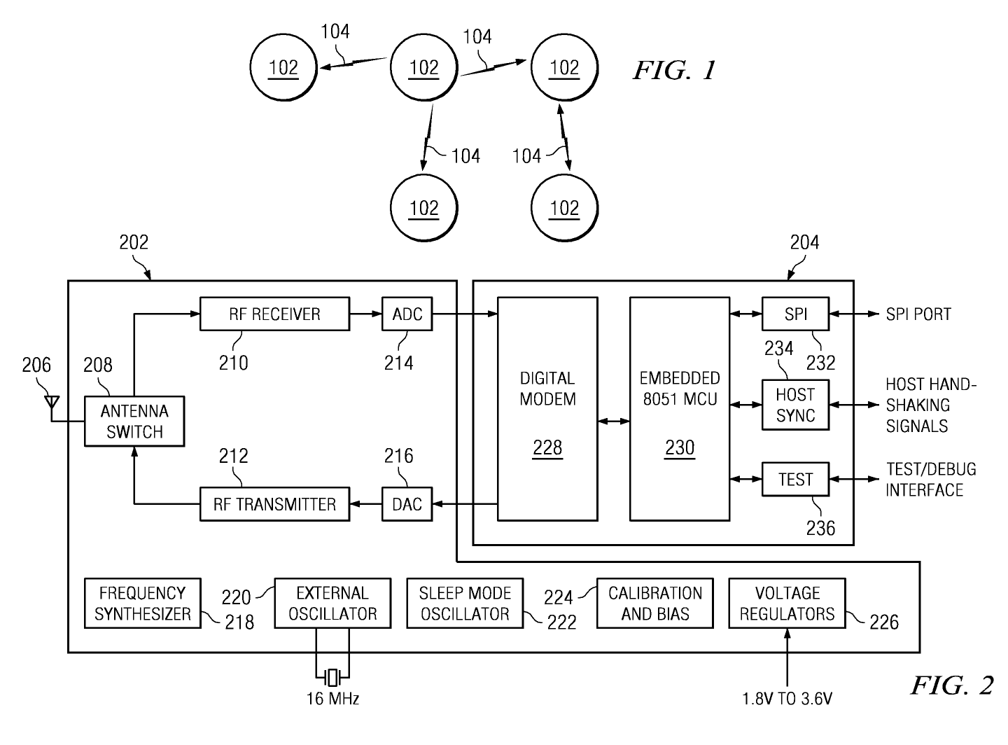

Referring now to FIG. 1, there is illustrated a low rate wireless personal area network (LR-WPAN) such as an 802.15.4 network. However, it should be realized that other wireless networks communicating between a number of RF transceiver devices may also utilize the improvements described herein. A low rate wireless personal network network (LR-WPAN) is a network designed for low cost and very low power short range wireless communications. A number of RF transceivers 102 may communicate with each other over various wireless links 104. The RF transceivers 102 may comprise single chip devices which are associated with sensors or other portable devices that are moving around or located within a defined and limited area. WPANs are used to convey information over relatively short distances among the participant transceivers 102. WPANs have little or no infrastructure enabling small power efficient inexpensive solutions to be implemented for a wide range of devices. Wireless transceiver devices 102 of this type may be used for various applications such as stick-on sensors, virtual wires, wireless hubs, or cable replacement. Other application are of course possible.

To achieve low power operation, each of the transceivers is operable to operate in a sleep mode, periodically “waking up” and either listening for some communication directed to itself or transmitting information to another one of the transceivers. When transmitting, the data is only transmitted in short bursts. Although asynchronous in operation, the timing between transceivers in a network is such that they wake up generally at a common time. The signal they are trying to listen for is referred to herein as a “signal of interest.” A problem arises when there are other transmitting devices operating in the same frequency band that are not in the network. For example, IEEE 802.11 wireless devices and Bluetooth wireless devices all operate in the 2.45 GHz band associated with the transceivers of the present disclosure. If one of these devices is transmitting during the data burst associated with the signal of interest, i.e., an interferer is present, the transceiver must account for this. The result is an overall increase in the inband spectral energy content, which can cause saturation if not accounted for. Additionally, it is possible for the interferer to be present for only a short period of time during the data burst.

Referring now to FIG. 2, there is illustrated a block diagram of one potential configuration of an RF transceiver chip that may utilize the automatic gain controller of the present disclosure. The RF transceiver chip consists of an analog portion 202 and a digital portion 204. The analog portion 202 includes the analog circuitry necessary for transmitting and receiving the RF signals, i.e., the RF front end. This portion is responsible for receiving the signal at the 2.45 GHz carrier frequency and dividing it into the I- and Q-quadrature signals at an intermediate or base band frequency. An antenna 206 connects with an antenna switch 208. The antenna switch 208 switches the antenna between the RF receiver circuitry 210 and the RF transmitter circuitry 212. The RF receiver circuitry 210 is responsible for receiving RF signals transmitted to the transceiver chip, and the RF transmitter circuitry 212 controls transmission operations from the chip. The receiver circuitry 210 is interfaced with the digital portion 204 of the chip through an analog-to-digital converter 214. The analog-to-digital converter 214 converts received analog signals from the RF receiver 210 into a digital format. The RF transmitter circuitry 212 is interfaced with the digital portion 204 of the RF transceiver chip via a digital-to-analog converter 216. The digital-to-analog converter 216 converts digital signals from the digital portion 204 into analog signals useable by the RF transmitter circuitry 212.

The analog circuitry 202 additionally includes a frequency synthesizer 218, external oscillator circuit 220, sleep mode oscillator 222, calibration and bias circuitry 224 and voltage regulators 226. The frequency synthesizer 218 generates the frequencies necessary for performing RF modulation and demodulation operations within the RF receiver 210 and the RF transmitter 212. The external oscillator circuitry 220 comprises the circuitry for generating the oscillator signals necessary for operation of the digital portion 204 and analog portion 202 responsive to an external oscillator crystal signal provided thereto. The sleep mode oscillator 222 provides oscillation signals to the digital portion 204 and analog portion 202 while the digital portion 204 is in a sleep mode of operation. This would be a mode between the receive and transmit operations of the RF transceiver chip. The sleep mode oscillator circuitry 222 minimizes power requirements of the RF receiver chip. The chip requires most power during transmitting and receiving periods of time, and the remainder of the time the chip is in a power down or sleep mode to conserve system power. The calibration and bias circuitry 224 provides the circuitry for controlling various calibration and biasing operations for the analog portion 202 of the RF transceiver chip. Voltage regulators 226 regulate an applied voltage of 1.8 volts to 3.6 volts to the levels necessary for operation within the analog and digital portions of the RF transceiver chip.

The digital portion 204 of the RF transceiver chip consists of the digital modem 228 and an embedded MCU 230. The digital modem 228 provides for the modulation and demodulation of digital signals provided between the MCU 230 and the analog-to-digital controller 214 and digital-to-analog controller 216 of the analog portion 202 of the RF transceiver chip. The digital modem 228 is realized with a DSP. The embedded MCU 230 is an 8051 based microprocessor that controls processing operations within the RF transceiver chip. The embedded MCU 230 includes interfaces to the external world via a SPI interface 232 connected to an associated SPI port, a host sync interface 234 which may communicate with external devices via handshaking routines, and a test interface 236 providing for test and debugging of the chip.

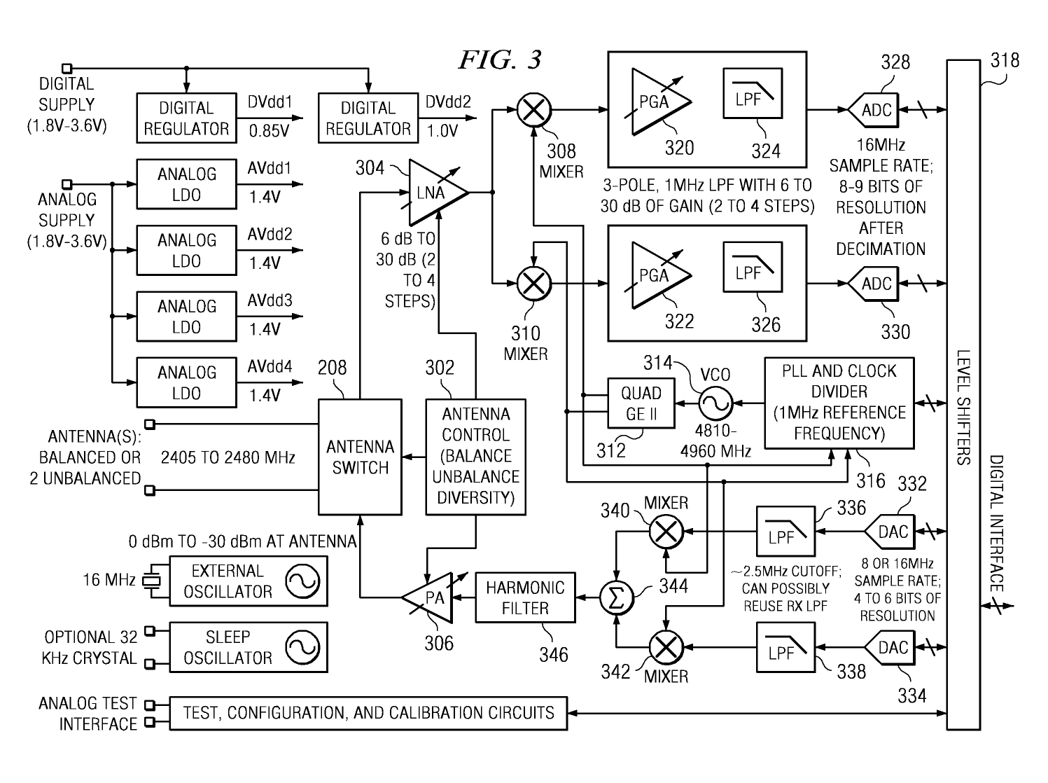

Referring now to FIG. 3, there is illustrated a block diagram of the analog portion 204 with respect to the RF receiver 210 and RF transmitter 212. The antenna switch 208 operates responsive to control signals from the antenna control block 302. The antenna switch 208 connects the antenna to either the RF transceiver input low noise amplifier 304 or to the power amplifier 306. The native received RF signals is provided from the low noise amplifier 304 to inputs of mixers 308 and 310, respectively. The low noise amplifier 304 also receives control signals from the antenna control block 302 for adjusting the gain thereof, this being a programmable gain amplifier. The mixer circuits 308 and 310 extract the quadrature I- and Q-components of the received RF signals using the 90 phase shifted local oscillator signals provided from the quadrature generator 312. The quadrature generator 312 receives a voltage control oscillator signal from voltage control oscillator 314 which is responsive to signals from the phase lock loop and clock divider circuit 316. The I- and Q-outputs of mixer circuits 308 and 310 are provided to the inputs of programmable gain amplifiers 320 and 322. The output of programmable gain amplifiers 320 and 322 are filtered through low pass filters 324 and 326 before being provided to associated analog-to-digital converters 328 and 330 for conversion to digital signals.

Signals for transmission are received through the level shifter 318 to the digital-to-analog converters 332 and 334 associated with the I and Q components respectively where the signals are converted to analog format. The outputs of the digital-to-analog converters 322 and 334 are filtered through low pass filters 336 and 338. The I and Q components of the composite signal are upconverted and combined within mixer circuits 340 and 342 responsive to the filtered signals from low pass filters 336 and 338 and mixing signals from the quadrature generator 312. The I and Q components upconverted by the mixers 340 and 342 are summed together at the summer circuit 344 and passed through a harmonic filter 346 to provide the composite RF signal at 2.45 GHz. The harmonic filter 346 provides an output to a programmable gain power amplifier 306 connected to the output antenna switch 208 and controlled by the antenna control circuitry 302. The programmable gain power amplifier 306 amplifies the signal to a desired level before being switched for output to the antenna.

The automatic gain control is implemented within the low noise amplifier 304 and/or the programmable gain amplifiers 320 and 322 via inputs provided to these amplifiers from a digital signal processor implemented within the digital portion 204 of the RF transceiver chip. By implementing the automatic gain control within one or both of these amplifiers to maximize desired signals while minimizing noise, the analog-to-digital converter 328 and 330 can avoid being placed in saturation conditions and provide for optimal reception of signals of interest being transmitted to the RF transceiver chip as will be described more fully herein below. This makes full use of the dynamic range of the overall RF front end. It is noted that the reason for the programmable gain amplifier 320 is to allow for a lower resolution analog-to-digital converter with a resulting lower power budget. However, it should be understood that a higher resolution data converter could be utilized with a much wider dynamic range, with the disadvantage of a much higher power budget.

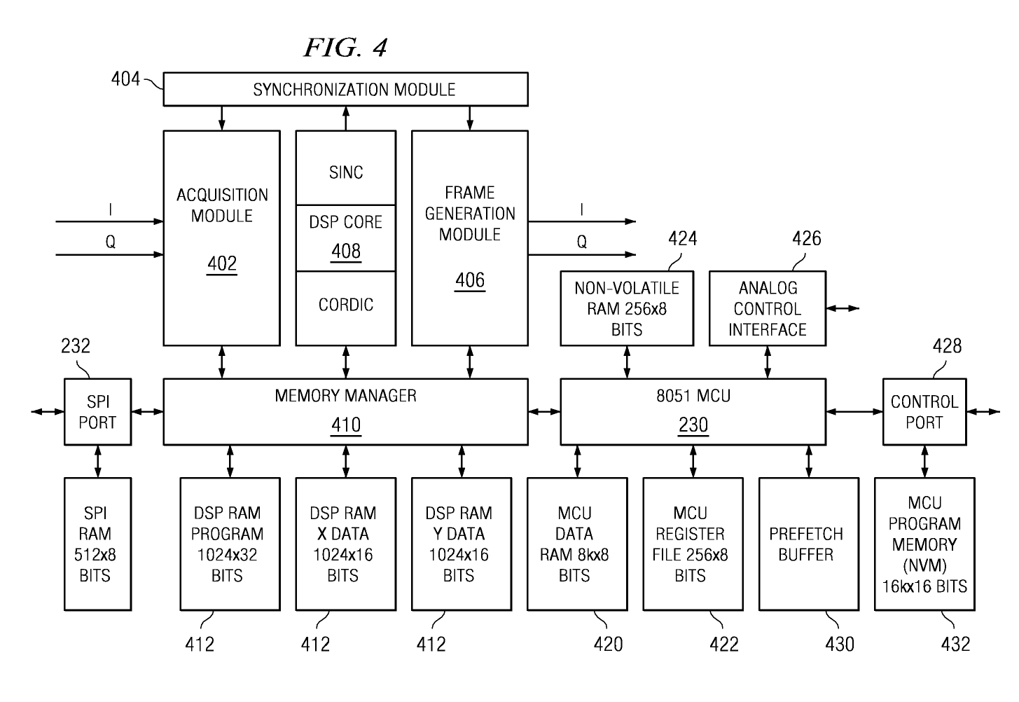

Referring now to FIG. 4, there is provided a block diagram of the digital portion 204 of the RF transceiver chip. Received RF signals from the analog-to-digital converter 214 are provided as I and Q components of the composite signal to an acquisition module 402. The acquisition module 402 receives control signals from a synchronization module 404 enabling the module to determine frame boundaries for received signals detected by the RF circuitry. Likewise, transmitted RF signals are provided as I and Q components of the resultant composite signal from the frame generation module 404 to the digital-to-analog converter 216. The frame generation module 404 also receives synchronization information from the synchronization module 404. A DSP core 408 provides control signals to the synchronization module 404 and is also responsible for providing the automatic gain control to the low noise amplifier 304 and programmable gain amplifiers 320 and 322 of the analog portion 202.

A memory manager 410 manages the various RAM memories 412 associated with the DSP core 408. The memory manager 410 is also in communication with the embedded MCU 230 and a SPI port 232. The MCU 230 also has associated RAM 420, an MCU register file 422, a non-volatile RAM 424 and an analog control interface 426. Control signals may be provided to the MCU 230 via a control port 428. A prefetch buffer 430 obtains MCU program memory instructions from program memory 432 when needed by the MCU 230.

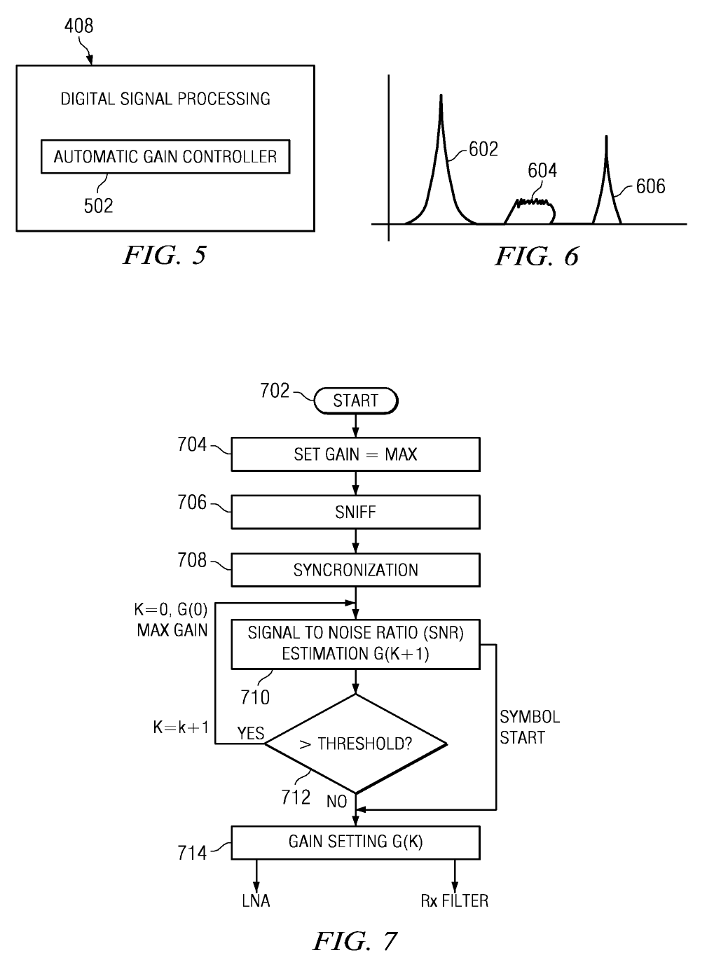

By implementing an automatic gain controller 502 within the digital signal processor 408 as illustrated generally at FIG. 5, various signals of interest may be amplified while minimizing signals that are noise or interferer signals. In a preferred embodiment, the automatic gain controller 502 will provide a minimum of three different gain levels and a maximum of 5 different gain levels. The goal of the automatic gain controller 502 is to avoid any saturation of the devices within the RF transceiver in order to be able to filter out adjacent signal interferers which may be detected. If the input of the receiver filter 324 is saturated it cannot properly filter out interferer signals and the harmonics of the interferer signals will fall in band. The RF transceiver has a finite number of gain levels in the low noise amplifier 304 and receive filter 324 in order to reduce the complexity of the system. An accurate AGC algorithm is needed in order to set this gain level since an error in the choice of the gain level cannot be tolerated. The gain of the AGC 502 is established after receiving the signal of interest. Thus, the symbol synchronization must be known before changing the gain. Furthermore, the synchronization algorithm must not be sensitive to saturation as gain levels which may achieve saturation must be tested to determine their possible use.

Referring now also further to FIG. 6, there are illustrated the different signals which may be received by the RF transceiver chip within the bandwidth of the receiver (noting that they are all overlapping, but illustrated as separate signals for clarification purposes). Signal 602 represents a signal of interest that is being transmitted to the RF transceiver. This is a spread spectrum signal utilizing single carrier QPSK modulation transmitted by a corresponding transmitter in the network, which signal, when demodulated, has a predetermined sequence of symbols. This is the signal which the RF transceiver is intended to receive, i.e., the signal of interest. Signal 604 represents a noise signal received by the RF transceiver. This is the general background noise that is often received over an RF channel and is of a substantially lower signal strength value than a signal of interest in most cases. Finally, an interferer signal 606 comprises a signal that is being transmitted on the same channel as the signal of interest 602 but is not intended for reception by the RF transceiver chip, although it also may be a QPSK signal. The interferer signal 606 is much larger than the noise signal 604 and in some cases may be strong enough to drown out or preempt the signal of interest 602. The desire is to avoid saturation at the input of the Rx filter in order to filter out properly the interferers 606. If the input signal already saturates the RF chain then an upcoming out of band interferer will create spur inband. In order to achieve these goals of minimizing the interferer signals 606 to maximize reception of signals of interest 602, the automatic gain controller 502 is implemented as software within the digital signal processor 408. It is important that the signal of interest be maintained at a sufficient signal level to adequately demodulate it, but also not allowing the interferer to cause saturation of the RF front end. Thus, it is the goal of the automatic gain control to seek a level that maximizes the ratio of the signal of interest to the sum of the interferer plus noise. In effect, the interferer is considered to be noise. As will be described in more detail herein below, what is necessary is to detect the presence of the signal of interest in the band and then with autocorrelation, determine the signal level thereof separate form the other received signals. With this signal level, the above noted ration can be determined and maximized.

The IEEE 802.15.4 signal is a constant envelope signal and thus very robust to saturation. Saturating the analog low pass filters 324 and 326 and the analog-to-digital converters 328 and 330 should be avoided as much as possible especially when an interferer signal 606 is present as this can potentially make the signal of interest and the interferer signal of similar strengths. The AGC 502 implemented within the DSP 408 provides gain control for the RF transceiver in a series of fixed steps. The DSP is always late by one buffer length when receiving and evaluating received RF signals. The AGC 502 always initially establishes the analog gain signal to a maximum gain value at wake up in order to reach the desired sensitivity level. If the analog gain is not at a maximum level when the DSP is trying to detect the presence of a signal, it is possible to miss some of the received signal, as this is a short burst of data. Therefore, it is important to wake up at maximum gain, as opposed to initiating the gain control from a medium level of gain.

The AGC algorithm relies upon the power levels of the signal of interest and the SNR of this signal. The following equation represents the model for the received signal z(k):

z(k)=G_{AGC}x(k)exp(2iπΔfk)+G_{AGC}i(k)+n_{RF}(k) (1)

G_{AGC} comprises the gain level of the automatic gain controller 502. This gain level will of course vary depending upon which gain level is ultimately chosen. x(k) comprises the signal of interest. The power of the signal of interest depends upon the propagation conditions within which the signal is being transmitted. Δf is the frequency offset in base-band used by the receiver and the transmitter of the transceiver. i(k) comprises the received interferer signal within any received signal z(k). n_{RF}(k) comprises any received noise signals received by the RF stage. The digital signal processor 408 within which the AGC 502 is implemented will have a sampling frequency at its input of 2 MHz.

Equation 2 represents the power Px of the signal of interest x(k).

Pₓ=G²_{AGC}E[x(k)x(k)*] (2)

In order to estimate Pₓ the periodicity of the preamble of the signal of interest is utilized. Pₓ comprises the power of the received signal of interest. E is the expectation. As before x(k) comprises the signal of interest and x(k)* comprises the complex conjugate of the symbol of interest x(k).

In order to estimate the power of the received signal of interest, the periodicity of its preamble is determined utilizing using the following equation:

C32=E[z(k)z*(k+32)] (3)

This is an estimator of the 32-order self correlation. 32 samples correspond to 16 microseconds at 2 MHz. The value of C32 measures the periodicity of the received signal. C32 is maximal when the signal z(k) is periodical with a period 32. In our case the received signal x(k) is periodical whereas the noise (RF and interferers) is a random signal which is not 32 periodical. As the noise is not 32-periodical the contribution of the noise in C32 defined in (3) becomes very small compared with the contribution of the signal of interest x(k). It can be demonstrated that the power of the preamble C32 calculated based upon samples belonging to the preamble are equal to the received signal power as soon as the interferer signal is non periodical or at least has a period greater than the 16 microsecond sampling period. This provides equation 4 as illustrated below:

C32=Pₓ (4)

An estimation of the power of the preamble C32 and the power of the total received signal power Pz are used to estimate the signal to adjacent interferer ratio (SAIR) and signal to noise ration (SNR). Pz represents the power of the received signal and is defined by the following equation:

Pz=[z(k)z*(k)]=G²_{AGC}(Pₓ+Pᵢ)+P_{NRF}

Pᵢ comprises the power of the interferer signal, Pₓ comprises the power of the received signal of interest and P_{NRF} comprises the power of the RF noise. P_{NRF} depends upon the RF stage noise factor and to a small degree on the gain of the automatic gain controller that is selected so this value is fixed and known.

Referring now to FIG. 7, there is illustrated the process for establishing a gain level using the automatic gain controller 502 within the digital signal processor 408. The process is initiated at step 702 when the RF transceiver wakes up from sleep mode and attempts to detect received RF signals. At wake up, the AGC 502 sets the gain of the analog gain controller 502 to a maximum level at step 704. The DSP sniffs at step 706 for an 802.15.4 signal at this maximum gain level with the expected symbol sequence periodicity. If an 802.15.4 signal is detected, the preamble of the detected signal is decoded such that synchronization estimators may be measured for the detected signal to detect the beginning of various data symbols within the detected signal, noting that the buffers may have one boundary and the actual data may and usually does have a different boundary at step 708. Once synchronization for the signal has been established, the detected channel power estimation and SNR of the signal of intent may be made at step 710 enabling the analog gain controller 502 to make a first decision. This estimation is based on the estimation of C32 (equation 3) and Pz (equation 5). Once the detected signal is autocorrelated to itself, the autocorrelation order depends on the preamble periodicity. Within a 16 micro second sample period, an estimation may be made of the total signal strength of the received signal of interest separate from other received signals, as shown in equation 3, even other QPSK signals, such as those associated with 802.11 standards. Once the estimated received signal strength power has been determined for the signal of interest, the signal to noise ratio for the detected signal may be determined at step 710. The signal to noise ratio (SNR) would equal the power of the signal of interest divided by the power of the noise plus any detected interferer signal.

The signal to noise ratio is determined according to the equation:

$$SNR = \frac{C 32}{{P}_{z} - C 32} \qquad ( 6 )$$

The precision of the estimator of the SNR which depends on the choice of the estimator is taken into account by the choice of the SNR threshold which is utilized. The threshold is augmented by a factor which warrants that the targeted SNR will be reached after the gain setting is selected.

Inquiry step 712 determines the signal to noise ratio associate with the next gain is estimate by the DSP and if this “future” SNR is greater than a threshold SNR, the SNR associate with the next gain is determined at step 710. The gain is decreased because of the desire to filter a new incoming interferer during the demodulation of the signal of interest. When the determined SNR is smaller than the threshold SNR, the gain is set to the minimal gain that exceeded the threshold SNR at step 714. Thus, the gain is set to the minimal value in order to have a minimal SNR. This established gain level is used for controlling the LNA and/or PNA amplifiers using control signals provided by the automatic gain controller 502 within the DSP 508. The goal is to keep the RF gain as low as possible with respect to the received signal while providing some minimal SNR level with some predetermined margin provided for.

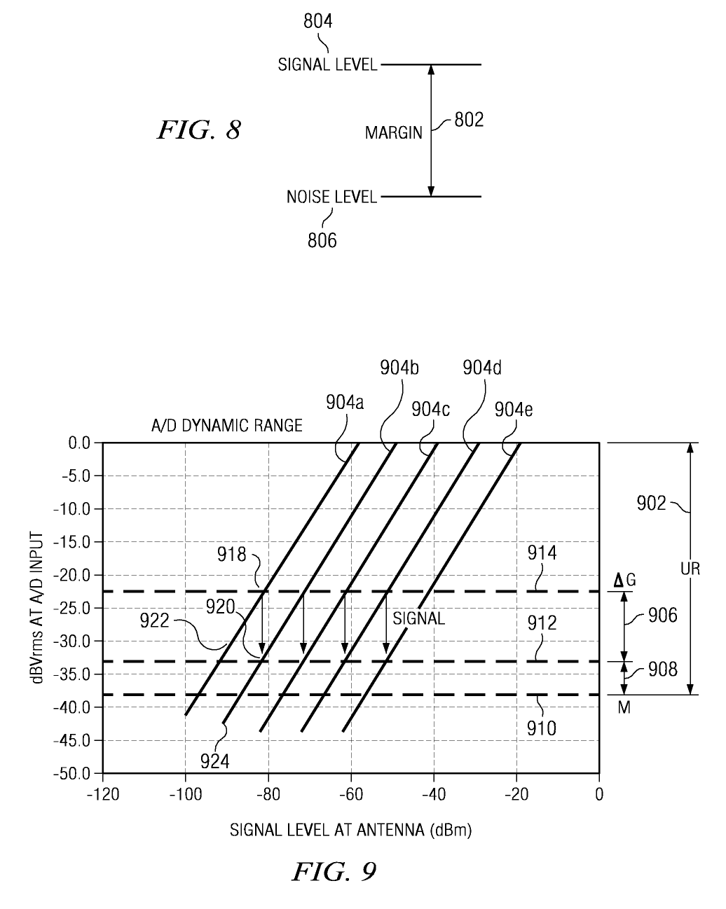

Referring now to FIG. 8, there is illustrated the margin range 802 that should be maintained between the detected signal power level 804 and the detected noise level 806. The detected signal power level 804 represents the signal strength of the signal of interest which is being received by the RF transceiver chip. This is the signal with which the RF transceiver chip is most interested, and the one that the gain level of the automatic gain controller is intended to maximize its reception. The detected noise level 806 represents the normal channel noise received by the RF transceiver chip plus any interferer signals which may be received by the RF transceiver chip. The goal of the automatic gain controller is to minimize the detected noise level 806 while maximizing the signal power level 804 to provide a signal to noise ratio creating a particular margin range 802 between the detected signal power level 804 and the detected noise level 806. This margin range 802 is intended to be of such a level that signal spikes caused by increases in the detected noise level which may arise from increased normal noise levels or increased interferer signal reception do not cause the noise to rise to such a level that the detected noise level 806 overwhelms and causes loss of the detected signal of interest. Thus, while spikes within the detected noise level may cause the noise to approach the signal strength levels of the detected signal, these levels will not usually match or exceed the received signal power level 804 if the desired margin range 802 is maintained. The precision of the estimation algorithm on the SNR fixes this margin. If the estimation algorithm gives the worst case precision of 3 dB and if we want to have an SNR more than 5 dB (at the demodulator input) the decision threshold is fixed at 8 dB. In fact if the estimator of the SNR gives 8 dB then in the worst case the SNR will be 5 dB which is the minimum SNR allowed to change the gain.

Referring now to FIG. 9, there is illustrated the manner in which the selection of varying gain levels affects the margin provided by the automatic gain controller with respect to the dynamic range of the analog-to-digital converter to which the signals are provided. The goal of the automatic gain controller is to prevent the analog-to-digital controller from entering its saturation region. As can be seen in FIG. 9, the full scale range 902 of the analog-to-digital converter goes from approximately −38 dbvrms to 0 at the input of the analog-to-digital converter. The diagonal lines 904 represent 5 different gain levels of the automatic gain controller 502. Line 904a represents the maximum gain level line and lines 904b through 904d respectively represent decreasing gain levels of the AGC. Line 906 represents the gain step delta G of a signal caused by lowering the gain to a next gain level. Line 908 represents the margin that must be provided above the signal to noise level 910 in order to assure that the reception of the signal of interest is maximized while minimizing the potential of interference arising from interferer signals or noise residing upon the receiving channel.

The bottom line 910 represents the noise level associated with the channel on which signals being received by the RF transceiver. Lines 912 and 914 and the area therebetween represent the potential signal strength levels associated with the signal of interest. The distance M between lines 910 and 912 represent the margin 908 which must be maintained between the signal level of the signal of interest and the noise level of the system. The gain of the automatic gain controller may not be lowered to such a level that the signal strength of the signal of interest received by the RF transceiver chip would drop below the level represented by line 912 or the detected signal level would drop below the permissible margin range. The space represented between lines 912 and 914 and indicated generally at 916 comprises the gain step delta G.

The gain step represents the amount that the signal strength of the signal of interest will decrease when gain is decreased from one gain level of the automatic gain controller to the next lower gain level. Thus, if the signal strength level of the signal of interest was approximately −24 dbvrms as indicated at point 918 for gain level 904a the gain level associated with the automatic gain controller may be decreased from gain level 904a to gain level 904b. This will cause the signal strength of the received signal of interest to decrease from the point indicated at 918 to the point indicated at 920 of approximately −35 dbvrms. Similar decreases can be seen when moving from points on the gain levels of the automatic gain controller along line 912. However, if the signal strength associated with gain level 904a were instead at −30 dbvrms (922), the gain level of the automatic gain controller could not be decreased to the next gain level 904b because this would take the signal strength of the detected signal of interest down to a point (924) below the desirable gain margin desired for operation of the transceiver. Thus, as can be seen, the gain step decrease caused by movement from a first gain level to a next lower gain level must maintain the signal strength of the received signal of interest above the margin level established for the system such that the signal to noise ratio will be maintained above a maximum desired level.

It will be appreciated by those skilled in the art having the benefit of this disclosure that this invention provides an automatic gain controller for use with an RF transceiver. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

1. An automatic gain controller for an RF transceiver, comprising:
a digital engine for selecting a gain level responsive to a power level of a signal of interest received by the RF transceiver in a defined radio frequency band in which other in band signals and background noise may be present; and
wherein the digital engine is configured to select the gain level from a plurality of possible gain levels to maximize the signal power of the signal of interest independent of the signal power of the other signals while providing at least a selected ratio of the signal power of the signal of interest to the combined signal power of the background noise and the other in band signals, the signal of interest to noise ratio.

2. The automatic gain controller of claim 1, wherein the digital engine is further configured to initially set the gain level to a maximum gain level.

3. The automatic gain controller of claim 2, wherein the digital engine is further configured to select each of the plurality of possible gain levels by decreasing gain level beginning with the maximum gain level.

4. The automatic gain controller of claim 3, wherein the digital engine is further configured to fix the gain level for the automatic gain when a presently selected gain level of the plurality of gain levels provides a signal of interest to noise level for the signal of interest less than a threshold signal of interest to noise ratio to a previously selected gain level by said digital engine.

5. The automatic gain controller of claim 3, wherein the digital engine selects a next smallest gain level of the plurality of gain levels when the selected gain level of the plurality of gain levels provides a signal of interest to noise ratio for the signal of interest greater than the threshold signal of interest to noise ratio.

6. The automatic gain controller of claim 1, wherein the digital engine detects the power level of the signal of interest received by the RF transceiver and determines the signal of interest to noise ratio responsive to the detected power level of the signal of interest.

7. The automatic gain controller of claim 1, wherein the digital engine provides the gain control to an output of a low noise amplifier.

8. The automatic gain controller of claim 1, wherein the digital engine provides the gain control to an output of a programmable gain amplifier.

9. The automatic gain controller of claim 1, wherein the digital engine further comprises a digital signal processor.

10. A method for providing automatic gain control within an RF transceiver, comprising the steps of:
selecting a gain level from a plurality of gain levels responsive to a signal power level of a signal of interest received by the RF transceiver in a defined radio frequency band in which other in band signals and background noise may be present, to maximize the signal power of the signal of interest relative to the other in band signals and background noise while providing at least a selected ratio of the signal power of the signal of interest to the combined signal power of the background noise and the other in band signals, the signal of interest to noise ratio; and
amplifying a received signal according to the selected gain level.

11. The method for providing automatic gain control of claim 10, wherein the step of selecting further comprises the step of setting an initial gain level to a maximum gain level.

12. The method for providing automatic gain control of claim 11, wherein the step of selecting further comprises the step of selecting at least a portion of each of the plurality of possible gain levels in decreasing gain level beginning with the maximum gain level.

13. The method for providing automatic gain control of claim 11, wherein the step of selecting further comprises the steps of:
determining a signal of interest to noise ratio for the signal of interest received by the RF transceiver for the selected gain level of the plurality of gain levels; and
fixing the gain level to a previously selected gain level when the selected gain level of the plurality of gain levels provides a signal of interest to noise ratio of the signal of interest less than the selected signal of interest to noise ratio.

14. The method for providing automatic gain control of claim 11, wherein the step of selecting further comprises the steps of:
determining a signal of interest to noise ratio for the signal of interest received by the RF transceiver for the selected gain level of the plurality of gain levels; and
selecting a next smallest gain level of the plurality of gain levels when the selected gain level of the plurality of gain levels provides a signal of interest to noise ratio of the signal of interest greater than the selected noise ratio.

15. The method for providing automatic gain control of claim 13, wherein the step of determining further comprises the steps of:
detecting the power level of the signal of interest received by the RF transceiver; and
determining the signal of interest to noise ratio responsive to the detected power level of the signal of interest.

16. The method for providing automatic gain control of claim 10, wherein the step of amplifying further comprises the step of amplifying the received signal according to the selected signal of interest to noise ratio within a low noise amplifier.

17. The method for providing automatic gain control of claim 10, wherein the step of amplifying further comprises the step of amplifying the received signal according to the selected signal of interest to noise ratio within a programmable gain amplifier.

18. An automatic gain controller for an RF transceiver, comprising:
a digital signal processor; and
a set of processing instructions for controlling the operation of the digital signal processor, said instructions configuring the digital signal processor to:
select a gain level from a plurality of gain levels responsive to a signal power level of a signal of interest received by the RF transceiver in a defined radio frequency band in which other in band signals and background noise may be present, to maximize the signal power of the signal of interest relative to the other in band signals and background noise while providing at least a selected ratio of the signal power of the signal of interest to the combined signal power of the background noise and the other in band signals, the signal of interest to noise ratio; and
provide a control signal to control amplifying the received signal of interest according to the selected signal of interest to noise ratio.

19. The automatic gain controller of claim 18, wherein the set of processing instructions further configure the digital signal processor to set an initial gain level to a maximum gain level.

20. The automatic gain controller of claim 19, wherein the set of processing instructions further configure the digital signal processor to select at least a portion of each of the plurality of possible gain level in decreasing gain level beginning with the maximum gain level until the selected signal of interest to noise ratio is achieved.

21. The automatic gain controller of claim 19, wherein the set of processing instructions further configure the digital signal processor to:
determine a signal of interest to noise ratio for the signal of interest received by the RF transceiver for the selected gain level of the plurality of gain levels; and
fix the gain level to a previously selected gain level when the selected gain level of the plurality of gain levels provides a signal of interest to noise ratio of the signal of interest less than the selected signal of interest to noise ratio.

22. The automatic gain controller of claim 19, wherein the set of processing instructions further configure the digital signal processor to:
determine a signal of interest to noise ratio for the signal of interest received by the RF transceiver for the selected gain level of the plurality of gain levels; and
select a next smallest gain level of the plurality of gain levels when the selected gain level of the plurality of gain levels provides a signal of interest to noise ratio of the signal of interest greater than the selected noise ratio.

23. The automatic gain controller of claim 21, wherein the set of processing instructions further configure the digital signal processor to:
detect the power level of the signal of interest received by the RF transceiver; and
determine the signal of interest to noise ratio responsive to the detected power level of the signal of interest.
